(19) United States
(12) Patent Application Publication
(10) Pub. No.: US 2026/0192755 A1
(43) Pub. Date: Jul. 9, 2026

(54) VEHICLE ROOF TRAY ASSEMBLY (I)

(71) Applicant: AutoPacific Australia Pty Ltd, Keysborough (AU)

(72) Inventors: Wilhelm Gerard Schneider-Loos, Chelsea Heights (AU); Douglas Ryan Studer, Berwick (AU)

(21) Appl. No.: 19/135,072

(22) PCT Filed: Dec. 1, 2023
(86) PCT No.: PCT/AU2023/051239

§ 371 Date: Jun. 2, 2025

(30) Foreign Application Priority Data
Dec. 2, 2022 (AU) 2022903677

(51) Int. Cl. B60R 9/045; B60P 7/08

(52) U.S. Cl. CPC B60R 9/045; B60P 7/0807

(57) ABSTRACT

The present invention provides a vehicle roof tray assembly (2) comprising: a perimetric frame (4a, 4b, 4c); and slats (8) arranged parallel to one another and extending between opposed sides of the frame (4a,4b), the slats being adjustably securable to said opposed sides of the frame such that respective positions of the slats can be adjusted along an axis that is generally parallel to the opposed sides of the frame.

### FIELD OF THE INVENTION

The present invention relates to a vehicle roof tray assembly.

### BACKGROUND OF THE INVENTION

Roof trays and assemblies thereof are routinely used to expand storage space and/or transport capacity of a motor vehicle. Typically, a roof tray assembly may be used to store and/or transport large or bulky items such as, for example, ladders, scaffolds, luggage, packages, etc., as well as sporting goods (e.g., bicycles, kayaks, skis, or surfboards), camping gear, and/or vehicle accessories. As such, roof tray assemblies are generally required to be secured to roof rack cross bars and to provide a container for the given item(s). It is also preferred that the roof tray assembly has a generally aerodynamic profile.

Conventionally, a roof tray assembly may be configured with a mounting structure that suits only one type or one category of cargo. That is, a particular roof tray assembly may not provide the ideal mounting structure or carrier for use with different types of cargo, thereby limiting its versatility and hence utility. It is commonly preferred that a roof tray assembly be able to accommodate different cargo items. Therefore, this deficiency has historically been addressed by affixing one or more mounting accessories to the roof tray assembly, where a given mounting accessory is adapted for use with a different cargo item.

This reliance on mounting accessories to provide versatility for a roof tray is, however, inherently problematic. Indeed, some changes or adaptations required to make a roof tray assembly compatible with a particular cargo may be impractical or even impossible from a manufacturing perspective. Additionally, mounting accessories are attached to roof racks using different mechanisms which are not universally compatible with roof tray assemblies. Therefore, a mounting accessory configured for use with a tray or roof rack from one manufacturer may prove incompatible with a tray or roof rack from another manufacturer.

Conventionally, roof tray assemblies are relatively fixed structures with a fixed number of support slats that are spaced apart are fixed positions. This can limit the usability of the roof tray assembly, particularly if the number of slats or the spacing therebetween is inadequate for the desired cargo to be transported, or when confronted with uneven loading scenarios.

There exists a need to overcome, or at least alleviate, one or more of the difficulties or deficiencies associated with the prior art. The present invention aims to substantially overcome or at least ameliorate one or more of the disadvantages of the prior art, or at least provide a commercial alternative to existing roof trays.

### SUMMARY OF THE INVENTION

According to a first aspect of the present invention, there is provided vehicle roof tray assembly comprising: a perimetric frame; and slats arranged parallel to one another and extending between opposed sides of the frame, the slats being adjustably securable to said opposed sides of the frame such that respective positions of the slats can be adjusted along an axis that is generally parallel to the opposed sides of the frame.

In embodiments of the assembly, each of the opposed sides of the frame comprise an inwardly extending support ledge along which the slats can be slidably adjusted. In certain embodiments, opposed ends of the slats are adjustably securable to the frame via the support ledges thereof. For example, each support ledge may comprise a channel extending along a length of the respective opposed side of the frame, wherein each channel is configured for receiving fasteners for adjustably securing the slats to the frame.

It is envisaged that each of the opposed ends of the slats is configured to receive therethrough one or more fasteners which extend into the respective channels of the opposed sides of the frame. In use, the fasteners may be locatable through openings formed in the slats, and slidable along the channels of the opposed sides of the frame.

Preferably, the fasteners are selectively tightenable to lock a position of the slats in place relative to the frame. In certain embodiments, the fasteners comprise mounting bolts.

In embodiments of the present assembly, the frame may comprise elongate members defining respective sides thereof, wherein at least one elongate member comprises a longitudinally extending mounting track along which tray attachments can be movably mounted. Each slat may also comprise at least one longitudinally extending mounting track along which tray attachments can be movably mounted.

In certain embodiments, the slats and/or the frame may comprise anchoring means for removably receiving hooks used in securing cargo to the tray assembly. The anchoring means comprise a longitudinally extending channel or ledge configured for receiving the hooks.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably be expected to be combined by a person skilled in the art.

The present invention will now be more fully described with reference to the accompanying examples and drawings. It should be understood, however, that the description following is illustrative only and should not be taken in any way as a restriction on the generality of the invention described above.

### BRIEF DESCRIPTION OF THE DRAWINGS/FIGURES

In order that the invention may be better understood and put into practical effect, reference will now be made to the accompanying drawings, in which:

FIG. 1 is a side perspective view of a vehicle roof tray assembly according to embodiments of the present invention;

FIG. 2A is a close-up cross-sectional perspective view of the assembly FIG. 1, the cross-section being taken through a frame of the assembly proximate to a slat adjustably secured thereto;

FIG. 2B is similar to the view of FIG. 2A but with the cross-section taken through both the frame and the slat to reveal a fastener for adjustably securing the slat to the frame;

FIG. 3A is a cross-sectional end view of the frame shown in FIG. 2A;

FIG. 3B is a cross-sectional end view of the slat shown in FIG. 2A;

FIG. 4A shows a cross-sectional perspective end view of a frame and slat of the present tray assembly cooperating with J-hooks; and

FIG. 4B shows a cross-sectional perspective end view of the slat of FIG. 4A cooperating with an S-hook.

### DETAILED DESCRIPTION OF THE EMBODIMENTS

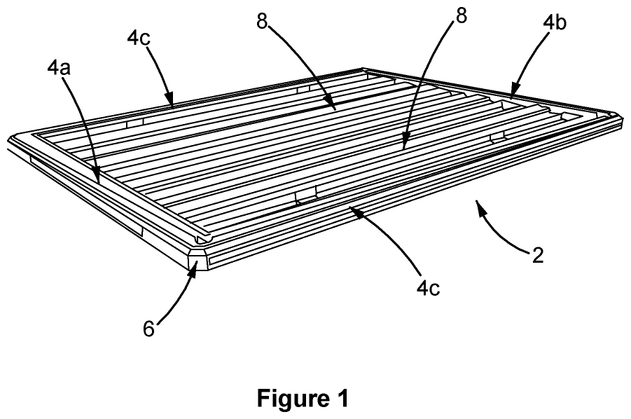

FIG. 1 shows a roof tray assembly 2 according to embodiments of the present invention. The assembly 2 is shown in an assembled state, and may also be referred to as a roof tray 2 in the present specification.

The roof tray assembly 2 comprises a perimetric frame 4 which substantially defines an area upon which cargo can be loaded. In the depicted embodiment, the frame 4 is formed from four elongate members 4a to 4c interconnected together via four corner connectors 6 to form the general shape of a rectangle. In particular, there are two elongate front and rear members 4a, 4b and a pair of elongate side members 4c. Of course, in embodiments of the present assembly 2, the elongate members 4 may be configured to connect with one another directly in cases where corner connectors 6 do not form part of the assembly 2.

The assembly 2 also comprises a plurality of slats 8 extending within the perimeter defined by the frame 4. The slats 8 are arranged parallel to one another and extend between opposed sides of the frame 4. In the depicted embodiment, the slats 8 extend between the front frame member 4a to the rear frame member 4b, though of course the slats 8 may instead extend between the two side frame members 4c. The assembled roof tray 2 can be connected to a crossbar of a roof rack (not shown) via known means to mount the tray 2 to the roof of a vehicle such as a car.

Traditionally, roof tray slats are secured to the perimetric frame at fixed positions. As such, known roof trays have a relatively fixed construction, wherein a particular tray will have a fixed number of slats secured at fixed positions. This can limit the versatility and usability of the roof tray and restricts the tray and slats thereof from being better adapted based on the loading requirements and conditions applicable to the cargo to be transported. The present vehicle roof tray assembly 2 enables the slats 8 to be adjustably secured to the frame. In certain embodiments, the slats 8 may be slid in a direction that is perpendicular to their longitudinal axes. As such, the position of the slats 8 relative to the frame 4 can be adjusted, and thus a spacing between slats 8 can also be varied to suit the loading conditions. It is also envisaged that the construction of the assembly 2 may be such that the number of slats 8 can be varied. For example, one or more slats 8 can be added to or removed from the frame 4 to suit cargo transport conditions.

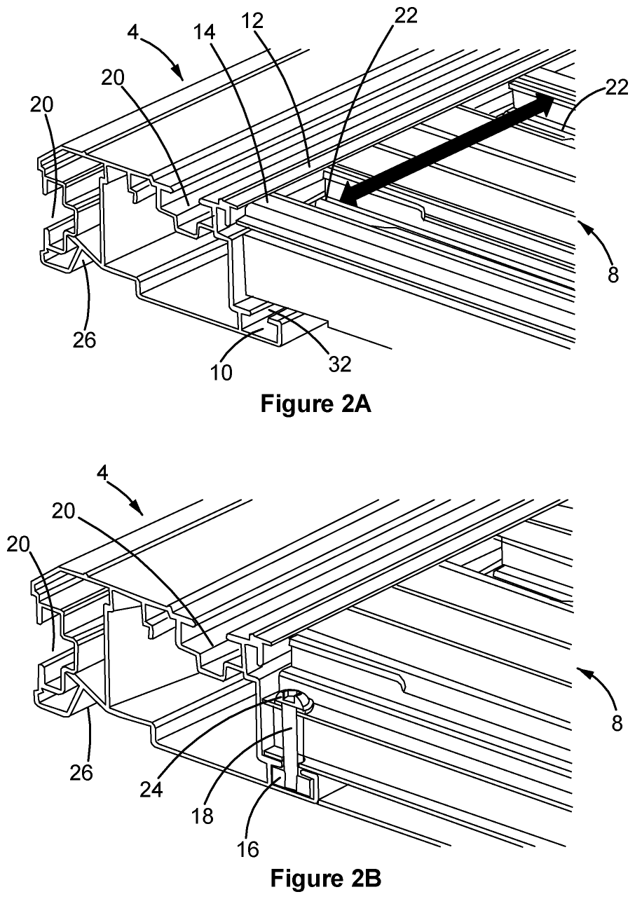

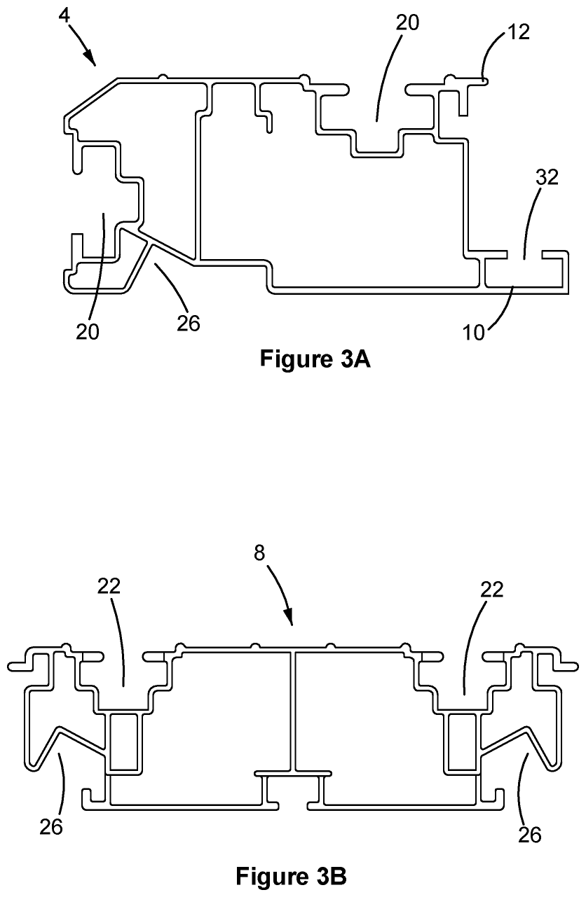

FIGS. 2A and 2B show a slat 8 where it meets and is secured to a perpendicularly arranged frame member 4. The cross-sectional profiles of the frame member 4 and the slat 8 are shown in FIGS. 3A and 3B, respectively. The frame member 4 and the slats 8 may be extruded from a material such as aluminium, though of course other manufacturing methods and materials are within the scope of the present specification. An inner side of the frame 4, that is the side that faces the area bound by the frame 4, comprises a lower and inwardly extending support ledge 10 for supporting the slats 8. In particular, the slat 8 is slidable along the ledge 10 to effect positional adjustment of the slat 8. In this way, the slat 8 is movable along an axis that is generally parallel to the frame member 4 to which it is adjustably secured. The frame member 4 may also have an upper and inwardly extending ledge 12 which can latch over an upper surface or end 14 of the slat 8. In this way, upon insertion of an end of a slat 8 between the upper and lower ledges 10, 12 and against the frame member 4, the slat 8 is only translatable in a direction that is parallel to the longitudinal axis of the frame member 4, which direction is represented by the double-headed arrow in FIG. 2A.

The support ledge 10 is in the form of a channel that extends along a length of the frame member 4. In the depicted embodiment, when viewed front-on (e.g., see FIG. 3A), the walls of the channel generally form the letter ‘C’ rotated anti-clockwise by 90 degrees. As such, the lower support ledge 10 comprises a longitudinally extending slot 32 (the slot 32 corresponding with the space between the arms of the C) configured to receive a fastener for adjustably securing the slat 8 to the frame 4. In particular, the fastener can be slid along the longitudinally extending slot 32 of the support ledge 10 and selectively fastened in place to fix a position thereof and thus an associated slat 8. Referring to FIG. 2B, the C-shaped channel of the lower support ledge 10 is shaped and sized to receive the nut end 16 of a mounting bolt 18, which mounting bolt 18 extends through the slat 8 to secure the slat 8 to the frame 4. The mounting bolt 18 can thus be loosened to enable the position of the slat 8 relative to the frame to be adjusted (i.e., slidingly translated relative to the frame 4 and along the length of the support ledge 10) and tightened to fix the position of the slat 8 relative to the frame 4 at the desired position. Advantageously, there is no need to drill holes in the frame members 4 for receiving alternative fasteners since the nut end 16 of the mounting bolt 18 simply slides within the channel of the lower support ledge 10. The omission of this drilling step may result in reduced manufacturing complexity and costs.

The frame members 4 may also be configured with longitudinally extending mounting tracks 20 via which tray attachments, accessories and the like may be removably and movably mounted. Referring to FIGS. 2A and 3A, the depicted frame member 4 comprises an outward-facing longitudinal track 20 and an upward-facing longitudinal track 20. When viewed front-on, the walls of each track 20 may define a T-shaped slot, though of course other shapes are within the scope of the present specification such that tray accessories, attachments and the like may slide therealong to a desired location and selectively fixed in place.

The slats 8 may also be configured with longitudinally extending mounting tracks 22 via which tray attachments, accessories and the like may be movably mounted. For example, with reference to FIGS. 2A and 3B, the slat 8 comprises laterally spaced apart tracks 22 extending along a length thereof. When viewed front-on, the walls of each track may generally form the shape of the letter ‘T’, though other shapes are within the scope of the present specification. Referring to FIG. 2B, the mounting bolts 18 may be received in through holes that are formed through a base of each of the longitudinal mounting tracks 22 of the slat 8 at locations near or at the opposed ends of the slat 8. In this way, the heads 24 of the mounting bolts 18 are visually obscured within the recessed track 22 and do not protrude upwardly in a way that might snag on items placed on the tray 2.

In use, the tray 2 may be assembled by bringing a plurality of slats 8 into engagement with the front and rear frame members 4a, 4b. Opposed ends of each slat 8 can sit between the lower support ledge 10 and the upper ledge 12 wherein nuts 16 (e.g., T-nuts) are received in the C-shaped channel of the ledge 10 and corresponding intermediate lengths of the mounting bolts 18 extend through the slat 8 and the slot 32 of the lower ledge 10. The mounting bolts 18 can be tightened to lock the slats 8 to the frame member 4. To reconfigure the tray 2, mounting bolts 18 can be loosened and the position of the corresponding slats 8 can be adjusted or the slats 8 can be removed. Such reconfiguration may also be carried out by first removing at least one frame member 4 (e.g., the rear frame member 4b) to enable to movement, addition and/or removal of the slats 8.

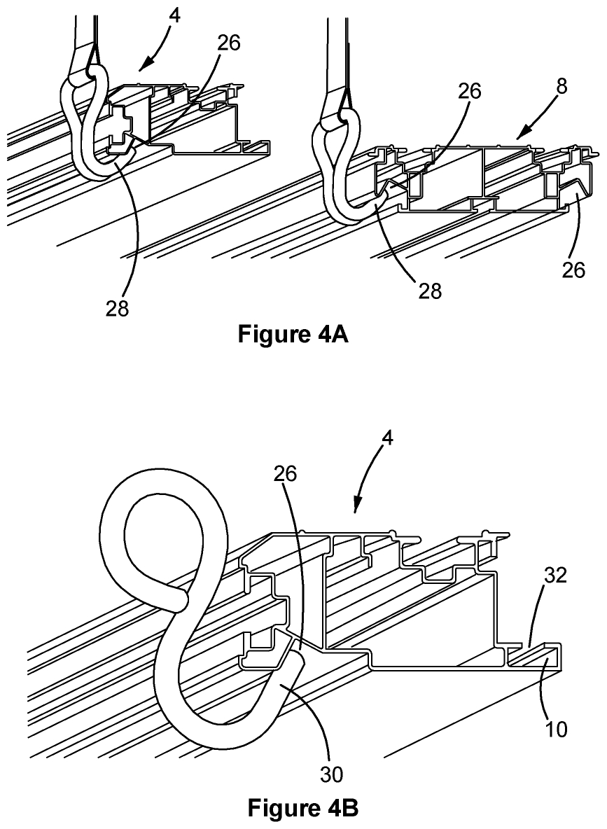

The slats 8 and frame members 4 are also formed with anchoring means via which components such as hooks and the like may be releasably fastened to strappingly secure cargo to the roof tray assembly 2. For example, with reference to FIGS. 4A and 4B, an underside of the frame 4 and slats 8 may be formed with one or more longitudinally extending ledges or channels 26 shaped to latchingly receive hooks, such as J-hooks 28 and S-hooks 30. Referring to FIGS. 3A and 3B, the walls of the channels 26 may resemble that of an upside-down V with inclined side walls, though other shapes which provide a ledge or surface which can be hooked is within the scope of the present specification.

Finally, it is to be understood that various alterations, modifications and/or additions may be made without departing from the spirit of the present invention as outlined herein.

1. A vehicle roof tray assembly comprising:
a perimetric frame; and
slats arranged parallel to one another and extending between opposed sides of the frame, the slats being adjustably securable to said opposed sides of the frame such that respective positions of the slats can be adjusted along an axis that is generally parallel to the opposed sides of the frame.

2. The assembly of claim 1, wherein each of the opposed sides of the frame comprise an inwardly extending support ledge along which the slats can be slidably adjusted.

3. The assembly of claim 2, wherein opposed ends of the slats are adjustably securable to the frame via the support ledges thereof.

4. The assembly of claim 2, wherein each support ledge comprises a channel extending along a length of the respective opposed side of the frame, each channel being configured for receiving fasteners for adjustably securing the slats to the frame.

5. The assembly of claim 4, wherein each of the opposed ends of the slats is configured to receive therethrough one or more fasteners which extend into the respective channels of the opposed sides of the frame.

6. The assembly of claim 5, wherein in use, the fasteners are locatable through openings formed in the slats, and slidable along the channels of the opposed sides of the frame.

7. The assembly of any one of claims 4, wherein the fasteners are selectively tightenable to lock a position of the slats in place relative to the frame.

8. The assembly of any one of claims 4, wherein the fasteners comprise mounting bolts.

9. The assembly of claim 1, wherein the frame comprises elongate members defining respective sides thereof, wherein at least one elongate member comprises a longitudinally extending mounting track along which tray attachments can be movably mounted.

10. The assembly of claim 1, wherein each slat comprises at least one longitudinally extending mounting track along which tray attachments can be movably mounted.

11. The assembly of claim 1, wherein the slats and/or the frame comprises anchoring means for removably receiving hooks used in securing cargo to the tray assembly.

12. The assembly of claim 11, wherein the anchoring means comprises a longitudinally extending channel or ledge configured for receiving the hooks.
